(19) United States
(12) Patent Application Publication
(10) Pub. No.: US 2007/0173314 A1
(43) Pub. Date: Jul. 26, 2007

(54) Sudoku game device with dual control button

(75) Inventors: Hsien-Tang Chen, Taipei (TW); Chen-Chun Lai, Taipei (TW); Shao-Ming Wu, Taipei (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Daka Studio Inc.

(21) Appl. No.: 11/340,127

(22) Filed: Jan. 26, 2006

(51) Int. Cl. G06F 19/00

(52) U.S. Cl. 463/18

(57) ABSTRACT

The present invention discloses a Sudoku device comprises a microprocessor; a Sudoku conditional module coupled to the microprocessor, wherein the Sudoku conditional module has a Sudoku puzzle program for creating a Sudoku puzzle; an input module coupled to the microprocessor, wherein a symbol may be entered into a blank cell on a grid by a directional button and an input button of the input module, wherein the microprocessor check the entered symbol by the Sudoku puzzle and if the entered symbol can not fit symbols Sudoku puzzle, then an indication may be shown on the display for re-entering another symbol into the blank cell; a display interface coupled to the microprocessor; a display coupled to the display interface, wherein the display may be shown the data of executing or completed Sudoku on the display processed by the microprocessor through the display interface coupled to the display; and a power source coupled to the microprocessor and the display interface.

### FIELD OF THE INVENTION

The present invention relates to a number place game device, and more particularly, relates to the game device which may determine whether a symbol place is proper by Sudoku puzzle.

### BACKGROUND OF THE INVENTION

### Description of the Related Art

Sudoku is a placement puzzle, also known as number place. Generally, the aim of the puzzle is to enter a numeral from 1 (one) through9 (nine) in each cell of a grid, most frequently a 9×9 grid made up of 3×3 sub grids (called “regions”), shown in FIG. 1. Sudoku begins with some of the grid cells filled with numbers (the “givens”), shown in FIG. 2. Each row, column and region must contain only one instance of each number. Completing the puzzle requires patience and logical ability.

Moreover, Sudoku will exercise the logical side of your brain, and though the puzzles are amazingly simple, solving these puzzles will definitely challenge you. As described above, every row and column contains the digits from 1 (one) through 9 (nine). Each of the nine 3×3 regions will also contain one of the digits. Knowing this, and with a few cells exposed, you can deduce the other cells until the entire grid is filled.

FIG. 3a˜3c shows a view of Sudoku puzzle. The object of Sudoku is to fill the other empty cells with numbers between 1 (one) through 9 (nine) (one number only in each cell) according to the following guidelines: 1. Number can appear only once on each row, shown in FIG. 3a; 2. Number can appear only once on each column, shown in FIG. 3b; and 3. Number can appear only once on each region, shown in FIG. 3c. The summary of these guidelines would be, that a number should appear only once on each row, column and a region.

Currently, the method for playing Sudoku comprises the following steps: 1. drawing nine 3×3 sub grids on a paper by a pencil and a rubber; 2. placing some digits on the sub grids; 3. entering digits from 1 (one) through 9 (nine) into all blank cells on the grid until each row, column and 3×3 box contain the digits 1 through 9 once and only once.

The aforementioned method for playing Sudoku has some drawbacks, for example wasting energy, eyesight and time owing to checking place number again and again; repeatedly trying and correcting by erasing, re-placing and checking place number continuously in the condition without meeting the requirement of the play puzzle, thereby resulting in paper broken and inconvenient to play. Moreover, the playing method of the conventional Sudoku game needs many buttons, in general above nine buttons or more, to proceed the playing, and therefore it causes to waste material made of the Sudoku device and difficultly control the buttons by the users.

Therefore, in view of the above-mentioned of the prior art, a new Sudoku device may be provided to achieve a purpose for convenient play to overcome the above drawbacks.

### SUMMARY OF THE INVENTION

In view of the drawbacks of prior art, which is produced of wasting energy, eyesight and time owing to checking place number again and again; repeatedly trying and correcting by erasing, re-placing and checking place number continuously in the condition without meeting the requirement of the play puzzle, the present invention provides a new Sudoku device.

In accordance with the purpose of the present invention, the invention provides a device with a Sudoku game module comprising a microprocessor; a Sudoku conditional module coupled to the microprocessor, wherein the Sudoku conditional module has a Sudoku puzzle program for creating a Sudoku puzzle; an input module coupled to the microprocessor, wherein a symbol may be entered into a blank cell on a grid by a directional button and an input button of the input module, wherein the microprocessor check the entered symbol by the Sudoku puzzle and if the entered symbol can not fit Sudoku puzzle, then an indication may be shown on the display for re-entering another symbol into the blank cell; a display interface coupled to the microprocessor; a display coupled to the display interface, wherein the display may be shown the data of executing on the display processed by the microprocessor through the display interface coupled to the display; and a power source coupled to the microprocessor and the display interface, wherein the power source provides a power to the microprocessor, the display and the dual-buttons input module.

The Sudoku device further comprises a switch coupled to the power source and a memory coupled to the microprocessor.

When the symbols entered into all blank cells are filled, the microprocessor detects that the Sudoku is finished, followed by sending an indication of Sudoku complete signal through the display and allowable for erasing the symbols on the grid for re-starting of Sudoku.

An action of short release of the directional button represents a signal of cursor forwarding and an action of pressing of the directional button to a predetermined time represents a signal of cursor backward until an action of releasing the cursor.

An action of short release of the input button represents a signal of changing the selected symbol, and an action of pressing the input button to a predetermined time represents a signal of confirming the selected symbol.

According to another aspect of the present invention, a four-buttons input module is coupled to the microprocessor, wherein a symbol may be entered into a blank cell on a grid by two-directional buttons and two-input buttons of the four-buttons input module.

The two-directional buttons comprise a forward button for moving the cursor cell to a next forwarding cell, and a backward button for moving back the cursor to a previous cell, and wherein the two-input buttons comprises a symbol button for changing the symbol to be inserted into the cursor cell, and a confirmation button for confirming the symbol to be inserted into the cell.

The indication shown on the display and controlled by the microprocessor indicates that the repeated symbol cell on the same row, column or a region of the grid returns to the null cell.

When Sudoku begins, some of the grid cells is filled with symbols crested by a random access producer of the microprocessor by pressed the input button, thereby the microprocessor may check and command the symbols fitting the Sudoku puzzle.

The directional button and the input button are substantially simultaneously pressed to erase the symbols on the.grid such that Sudoku may be re-started. The pressed may be finished by substantially simultaneously pressing short release or pressing a predetermined time of the directional button and the input button.

The directional button and the input button are substantially simultaneously pressed to set the given symbols created by the microprocessor as a default symbols which can not be changed and erased. The pressed may be finished by substantially simultaneously pressing a forward button or a backward button of the directional button and a symbol button or a confirmation button of the input button.

The above-mentioned grid comprises m×m cells, wherein the number of m is an integer from four to nine. The sub grids of the grid are asymmetric on 5×5 cells.

### BRIEF DESCRIPTION OF THE DRAWINGS

For a better understanding of the present invention and to show how it may be carried into effect, reference will now be made to the following drawings, which show the preferred embodiments of the present invention, in which:

FIG. 1 shows a view of a 9×9 grid made up of 3×3 sub grids.

FIG. 2 shows a view of Sudoku beginning with some of the grid cells filled with numbers.

FIG. 3a˜3c shows a view of Sudoku puzzle.

FIG. 4 shows a Sudoku device according to the present invention.

FIG. 5 shows a functional diagram of Sudoku device according to the present invention.

FIG. 6 shows a view of Sudoku beginning with some of the grid cells made of four 2×2 sub grids filled with numbers according to the present invention.

FIG. 7 shows a view of Sudoku beginning with some of the grid cells made of five sub grids filled with numbers according to the present invention.

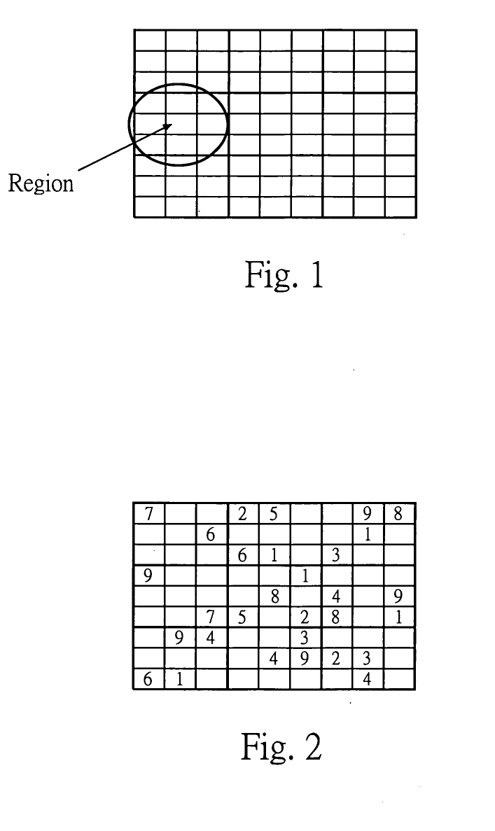

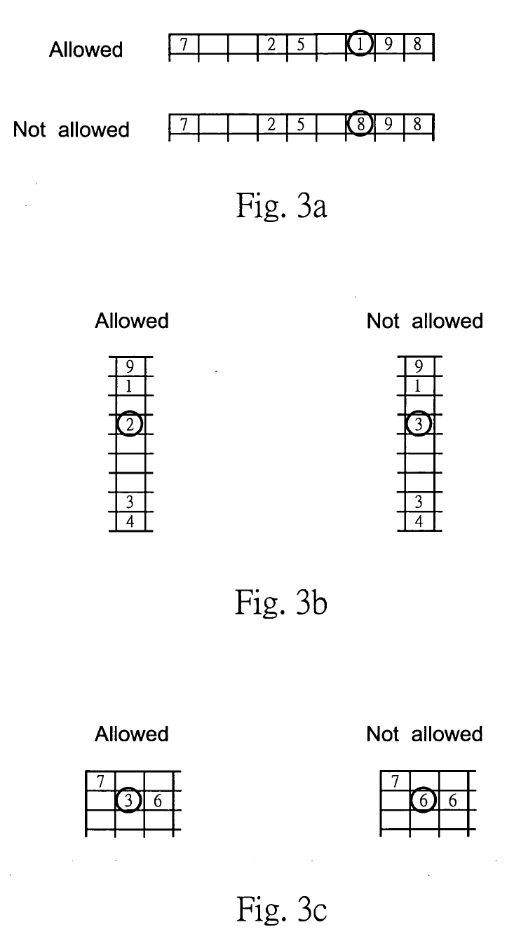

### DESCRIPTION OF THE PREFERRED EMBODIMENTS

In the following description, numerous specific details are set forth in order to provide a thorough understanding of the present invention, and the scope of the present invention is expressly not limited expect as specified in the accompanying claims. One skilled in the relevant art will recognize, however, that the invention may be practiced without one or more of the specific details.

Those of ordinary skill in the art will immediately realize that the embodiments of the present invention described herein in the context of methods and schematics are illustrative only and are not intended to be in any way limiting. Other embodiments of the present invention will readily suggest themselves to such skilled persons having the benefits of this disclosure.

The numerals in Sudoku puzzle are used for convenience; arithmetic relationships between numerals are absolutely irrelevant. Moreover, any set of distinct symbols will do, for example numbers, letters, geometric shapes, or colors may be used without altering the puzzle.

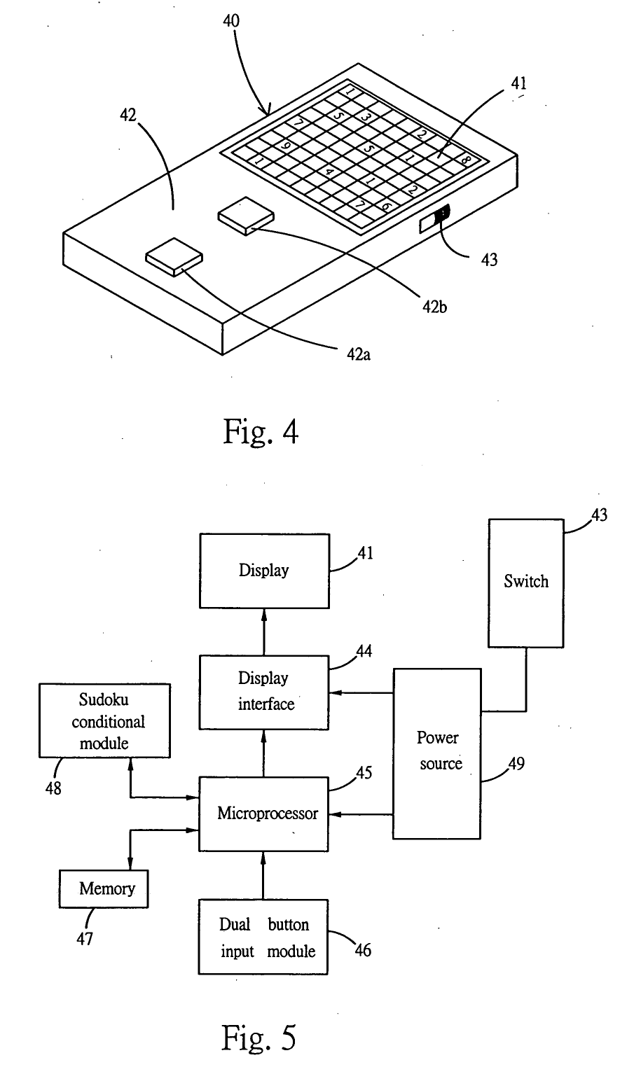

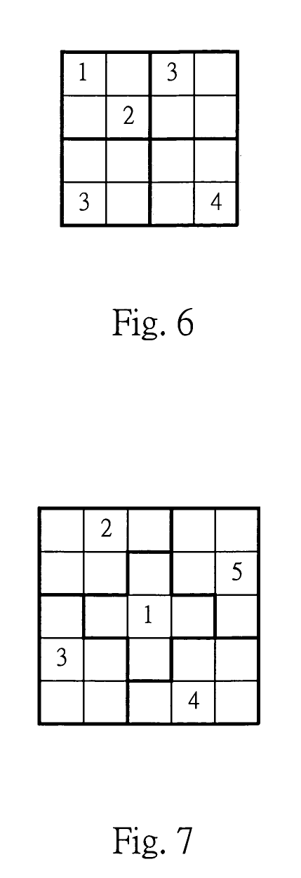

Referring to FIG. 4 and FIG. 5, it shows a Sudoku device according to the present invention. The Sudoku device comprises a main body 40, a display 41, a keyboard 42, a switch 43, a display interface 44, a microprocessor 45, an input module 46, a memory 47, a Sudoku conditional module 48 and a power source 49. In one embodiment, the input module 46 comprises two-buttons input module or four-buttons input module. The display 41 is disposed on the main body 40. For example, the display 41 is a LCD display. The display 41 is set to a grid comprised of m×m cells, wherein the number of m is from four to nine. For example, m is four. In this regards, the grid comprises four 2×2 sub grids (called “regions”), shown in FIG. 6. In another embodiment, m is nine, and then the grid comprises nine 3×3 sub grids, shown in FIG. 2. In yet another embodiment, m is five, and then the grid comprises five sub grids, shown in FIG. 7, wherein sub grids of the grid are asymmetric on 5×5 cells. A key area 42 may be disposed on the side of the display 41. One aspect of the present invention is two-buttons control. Therefore, the key area 42 comprises a directional button 42a for moving the cursor cell, and an input button 42b for inputting the symbols. The control of the buttons 42a, 42b will be described in detail later. The symbols comprise but not limited numbers, letters, geometric shapes or colors, as described above. In other words, the symbols may be inputted by the keys 42a and 42b. The switch 43 may be disposed on the side of the main body 40, and coupled to the power source 49 for switching the status of the Sudoku device on or off controlled by switch 43. The memory 47 may store data of user's name or play record etc.

The microprocessor 45 is disposed into the main body 40, and coupled to the power source 49. The microprocessor 45 is coupled to the Sudoku conditional module 48. The Sudoku conditional module 48 comprises a Sudoku puzzle program for generating a Sudoku puzzle. In one embodiment, the Sudoku conditional module 48 may be embedded into the microprocessor 45. The display interface 44 is disposed into the main body 40, and coupled to the microprocessor 45, the display 41 and the power source 49. The display 41 may be shown the data of executing or completed Sudoku processed by the microprocessor 45 through the display interface 44 coupled to the display 41. The microprocessor 45 is coupled to the power source 49 and the dual button input module 46 such that the power source 49 can provide a power source to microprocessor 45 and display 41 through the display interface 44. In other words, the direction of the cursor on the display is controlled by dual button input module 46 through the directional button 42a and the input button 42b.

Sudoku may be executed by the Sudoku device made of the above-mentioned elements. Sudoku begins with some of the grid cells filled with symbols such as given numbers crested by a random access producer (not shown) of the microprocessor 45 by pressed the input button 42b of the key area 42, shown in FIG. 6a. In the meanwhile, the microprocessor 45 may check whether the given numbers are fitted the Sudoku puzzle or not. And then, the directional button 42aand the input button 42b of the key area 42 are utilized to enter other symbols such as digits from 1 (one) through 4 (four) into all blank cells on the grid. The microprocessor 45 may check whether the entered symbols are fitted the Sudoku puzzle or not. The un-fitted symbols may be shown on the display 41 by an indication to remind user of re-entering another symbol into blank cell on the grid. again. The conventional method for playing Sudoku has a drawback of repeatedly trying and correcting by erasing, re-placing and checking place number continuously in the condition without meeting the requirement of the Sudoku puzzle which may be overcome by the automatically checking the entered symbols into all blank cells on the grid.

Referring to FIG. 4˜FIG. 7, when the symbols entered into all blank cells are filled, the microprocessor 45 may determine that the Sudoku is finished, followed by sending an indication of play completed through the display 41 and allowable for erase the symbols on the grid for re-starting of Sudoku. In one embodiment, the symbols may be numbers such as one, two, three and four; characters such as A, B, C and D.

Referring to FIG. 4˜FIG. 7 again, the key area 42 comprises one directional button 42a and one input button 42b. When Sudoku begins, some of the grid (or each one of the sub grids) cells is filled with symbols such as given numbers crested by a random access producer (not shown) of the microprocessor 45 by pressed the input button 42b of many times which the microprocessor 45 may check and command the given numbers fitting the Sudoku puzzle. In processing Sudoku, the directional button 42a may be utilized (pressed) to move the cursor cell on the display 41 to a location of the selected symbol. For example, an action of short release of the directional button 42a represents a signal of cursor forwarding and an action of pressing of the directional button 42a to a predetermined time represents a signal of cursor backward until an action of releasing the cursor. And then, a responsive symbol on the location determined by the microprocessor 45 may be shown on the display 41 by pressed the input button 42b of many times. For example, an action of short release of the input button 42b represents a signal of changing the selected symbol, and an action of pressing the input button 42b to a predetermined time represents a signal of confirming the selected symbol, and vice versa. In other words, the selected symbol may be determined by pressing a predetermined time the input button 42bafter short release of the input button 42b one or more times. The default control signal may be defined in the device and controlled by the dual button input module 46.

In another embodiment, the key area 42 comprises two directional buttons 42a and two input buttons 42b. The two directional buttons 42a comprise a forward button for moving the cursor cell to a next forwarding cell, and a backward button for moving back the cursor to a previous cell. Similarly, the two input buttons 42b comprises a symbol button for changing the symbol to be inserted into the cursor cell, and a confirmation button for. confirming the symbol to be inserted into the cell.

As described above, Sudoku puzzle follows guidelines that a symbol should appear only once on each row, column and a region. In other words, the same symbol can not appear on each row, column and a region. In one embodiment, the indication shown on the display 41 and controlled by the microprocessor 45 indicates that the repeated symbol cell on the same row, column or a region returns to the null cell.

As stopping Sudoku, the directional button 42a and the input button 42b may be substantially simultaneously pressed to erase the symbols on the grid (or each one of the sub grids) such that Sudoku may be re-started.

Moreover, the directional button 42a and the input button 42b may be substantially simultaneously pressed to set the given symbols created by the microprocessor 45 as a default symbols which can not be changed and erased.

The above pressing method may be determined by substantially simultaneously pressing short release or pressing a predetermined time of the directional button 42a and the input button 42b.

Besides, the above pressing method may be determined by substantially simultaneously pressing a forward button or a backward button of the directional button 42a and a symbol button or a confirmation button of the input button 42b.

In another embodiment, the device with a Sudoku game module of the present may be an electric game device, a mobile phone, a computer or a PDA (Personal Digital Assistant) . When Sudoku begins, some of the grid (or each one of the sub grids) cells is filled with symbols such as given symbols crested by a random access producer of the above device such that the microprocessor 45 may check and command the given symbols fitting the Sudoku puzzle. The given symbols may be set as default symbols.

Therefore, in contrast with the prior art having some drawbacks of wasting energy, eyesight and time owing to checking place number again and again; repeatedly trying and correcting by erasing, re-placing and checking place number continuously in the condition without meeting the requirement of the play puzzle, the present invention provides a new Sudoku device which may achieve a purpose for convenient play and overcome the above drawbacks.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A device with a Sudoku game module, comprising:
a microprocessor;
a Sudoku conditional module coupled to said microprocessor, wherein said Sudoku conditional module has a Sudoku puzzle program for creating a Sudoku puzzle;
a dual-buttons input module coupled to said microprocessor, wherein a symbol may be entered into a blank cell on a grid by a directional button and an input button of said dual button input module;
a display coupled to said microprocessor, wherein said display is used to show the data of executing on said display processed by said microprocessor; and
a power source coupled to said microprocessor and said display.

2. The device as in claim 1, wherein said microprocessor detects that the Sudoku is finished when said symbols entered into all blank cells are filled, followed by sending an indication of Sudoku complete signal through said display and allowable for erasing said symbols on said grid for re-starting of Sudoku.

3. The device as in claim 1, wherein an action of short release of said directional button represents a signal of cursor forwarding, and an action of pressing of said directional button to a predetermined time represents a signal of cursor backward until an action of releasing said cursor.

4. The device as in claim 1, wherein an action of short release of said input button represents a signal of changing the selected symbol, and an action of pressing said input button to a predetermined time represents a signal of confirming the selected symbol.

5. The device as in claim 1, wherein said device comprises an electronic game device, a mobile phone, a computer or a PDA (Personal Digital Assistant) .

6. The device as in claim 1, wherein said grid comprises m×m cells, wherein said m is an integer from four to nine.

7. A device with a Sudoku game module, comprising:
a microprocessor;
a Sudoku conditional module coupled to said microprocessor, wherein said Sudoku conditional module has a Sudoku puzzle program for creating a Sudoku puzzle;
a four-buttons input module coupled to said microprocessor, wherein a symbol may be entered into a blank cell on a grid by two-directional buttons and two-input buttons of said four-buttons input module;
a display coupled to said microprocessor, wherein said display is used to show the data of executing on said display processed by said microprocessor; and
a power source coupled to said microprocessor and said display.

8. The device as in claim 7, wherein said microprocessor detects that the Sudoku is finished when said symbols entered into all blank cells are filled, followed by sending an indication of Sudoku complete signal through said display and allowable for erasing said symbols on said grid for re-starting of Sudoku.

9. The device as in claim 7, wherein said two-directional buttons comprise a forward button for moving the cursor to a next forwarding cell, and a backward button for moving back the cursor to a previous cell.

10. The device as in claim 7, wherein said two-input buttons comprises a symbol button for changing said symbol to be inserted into the cursor cell, and a confirmation button for confirming said symbol to be inserted into the cell.

11. The device as in claim 7, wherein said device comprises an electronic game device, a mobile phone, a computer or a PDA (Personal Digital Assistant) .

12. The device as in claim 7, wherein said grid comprises m×m cells, wherein said m is an integer from four to nine.

13. A device with a Sudoku game module, comprising:
a microprocessor;
a Sudoku conditional module coupled to said microprocessor, wherein said Sudoku conditional module has a Sudoku puzzle program for creating a Sudoku puzzle, wherein a grid of said Sudoku comprises m×m cells, wherein said m is an integer that is four or five;
an input module coupled to said microprocessor to enter a symbol into a blank cell on said grid;
a display coupled to said microprocessor, wherein said display is used to show the data of executing on said display processed by said microprocessor; and
a power source coupled to said microprocessor and said display.

14. The device as in claim 13, wherein said microprocessor detects that Sudoku is finished when said symbols entered into all blank cells are filled, followed by sending an indication of Sudoku complete signal and allowable for erasing said symbols on said grid for re-starting of Sudoku.

15. The device as in claim 13, wherein said input module includes dual-bottoms input module having a directional button and an input button.

16. The device as in claim 15, wherein an action of short release of said directional button represents a signal of cursor forwarding, and an action of pressing of said directional button to a predetermined time represents a signal of cursor backward until an action of releasing said cursor.

17. The device as in claim 15, wherein an action of short release of said input button represents a signal of changing the selected symbol, and an action of pressing said input button to a predetermined time represents a signal of confirming the selected symbol.

18. The device as in claim 13, wherein said input module includes a four-bottoms input module having two directional buttons and two input buttons.

19. The device as in claim 18, wherein said two-directional buttons comprise a forward button for moving the cursor to a next forwarding cell, and a backward button for moving back the cursor to a previous cell.

20. The device as in claim 18, wherein said two-input buttons comprises a symbol button for changing said symbol to be inserted into the cursor cell, and a confirmation button for confirming said symbol to be inserted into the cell.

21. The device as in claim 13, wherein sub grids of said grid are asymmetric on 5×5 cells.
